(19) United States
(12) Patent Application Publication
(10) Pub. No.: US 2018/0281708 A1
(43) Pub. Date: Oct. 4, 2018

(54) OIL SENSOR SYSTEM

(71) Applicant: FORD GLOBAL TECHNOLOGIES, LLC, Dearborn, MI (US)

(72) Inventors: Michael Robert GARRARD, Jaywick Essex (GB); Jonathan THOMBS, Danbury Essex (GB)

(73) Assignee: FORD GLOBAL TECHNOLOGIES, LLC, Dearborn, MI (US)

(21) Appl. No.: 15/944,005

(22) Filed: Apr. 3, 2018

(30) Foreign Application Priority Data
Apr. 3, 2017 (GB) 1705341.4

(51) Int. Cl. B60R 16/023; G01F 23/24; G01K 7/24

(52) U.S. Cl. CPC B60R 16/0234; G08B 21/182; G01K 7/24; G01F 23/246

(57) ABSTRACT

A device to detect engine oil level and temperature. The device comprises: a thermistor; an unregulated, or voltage-only regulated, power supply configured to provide a non-continuous high current to the thermistor for a predetermined time in order to induce self-heating of the thermistor. An ADC (“Analog-Digital Converter”) configured to read a voltage across the thermistor before and after the heating of the thermistor. A processor is configured to calculate a change in temperature of the thermistor on the basis of a change in voltage measured by the ADC, and, thereby, deduce an engine oil level and temperature.

### CROSS-REFERENCE TO RELATED APPLICATIONS

This application claims foreign priority benefits under 35 U.S.C. § 119(a)-(d) to Application GB 1705341.4 filed Apr. 3, 2017, which is hereby incorporated by reference in its entirety.

### TECHNICAL FIELD

This disclosure relates to improvements in or relating to oil temperature sensors configured to identify absence of oil from an intended location.

### BACKGROUND

It is common practice to measure a temperature of oil in a vehicle engine. This is typically achieved through provision of a thermistor

In addition, considerable damage to the engine may occur if, for some reason, oil is absent from the system. It is therefore also known to provide an oil level sensor, which identifies a level of oil, and is configured to alert a driver if the level falls below a predetermined acceptable level. Oil level is measured through provision of a hot wire immersion type sensor, which requires a precise and relatively expensive constant current supply in an engine control module.

### SUMMARY

It is against this background that the present disclosure has arisen.

According to the present disclosure, there is provided a device to detect engine oil levels and temperatures. The device comprising: a thermistor; an unregulated, or voltage-only regulated, power supply configured to provide a non-continuous high current to the thermistor for a predetermined time in order to induce self-heating of the thermistor; a ADC configured to read voltage across the thermistor before and after heating of the thermistor; a processor configured to calculate a change in temperature of the thermistor on the basis of a change in voltage measured by the ADC and thereby to deduce an engine oil level and temperature.

In this context the term “high current” refers to currents that are sufficient to cause self-heating of the thermistor. This is in excess of lower currents that would typically be used to determine a value of resistance. A typical, temperature sensor thermistor may be read at a current of 500 μA with self-heating achieved at 10 mA. Specific current levels required for measurement and self-heating will vary based on a resistance range of the thermistor.

The use of an unregulated power supply is counter-intuitive, but it offers an opportunity for considerable efficiency improvements. Existing oil level sensing is typically achieved through use of a current regulated power supply. A current regulated supply is not typically available within the vehicle and must be added at extra cost. However, the use of a thermistor to measure both temperature and level using an unregulated, or regulated voltage, supply enables a reduction in cost.

The device may further comprise a storage device configured to store acceptable operating parameters and an alarm system configured to be triggered when a deduced engine oil level and/or temperature falls outside acceptable operating parameters.

The device may further comprise a voltage divider configured to separate the thermistor from the ADC.

The device may further comprise a control switch, which may be a p-channel metal-oxide semiconductor (PMOS). The control switch enables the device to be activated for a predetermined period of non-continuous operation. This provides a fixed burst of energy to the thermistor that will undergo self-heating. Depending on a specific heat capacity of fluid in which the thermistor is sitting, more or less of heat from the thermistor will be transferred into the surrounding fluid. The extent of heat transfer between the thermistor and oil will be significantly greater than if the thermistor is surrounded by air.

If the thermistor is surrounded by air, then the change in temperature of the thermistor as a result of heating facilitated by provision of power from the power supply will be much greater than if the thermistor is submerged in oil into which it can easily transfer heat. This change in thermistor temperature is determined by measuring the thermistor resistance at a beginning and end of a heating cycle.

Above a maximum acceptable change in temperature resulting from the self-heating, the device deduces that the thermistor is no longer surrounded by oil and therefore oil is at an unacceptably low level. An alarm can therefore be raised.

The temperature of the oil can be measured by connecting the power supply to the thermistor so that no significant self-heating occurs. This is done by applying power for a short period e.g. 5 μs and can be repeated to determine changes in temperature over time. This can be performed independently of a measuring level, if desired.

The device may further comprise a resistor in series with the switch to protect the switch.

The device may further comprise a reference voltage for a microcontroller unit (MCU). Some MCUs require a regulated voltage and the provision of a V_{REF} provides for this.

The disclosure will now be further and more particularly described, by way of example only, and with reference to the accompanying drawings, in which:

### BRIEF DESCRIPTION OF THE DRAWINGS

FIG. 1 shows a circuit that implements a first embodiment of a device according to the present disclosure;

FIG. 2 shows another circuit that implements a first embodiment of a device according to the present disclosure;

FIG. 3 shows a further circuit that implements a further embodiment of a device according to the present disclosure;

FIG. 4 shows a further circuit that implements an embodiment of a device according to the present disclosure;

FIG. 5 shows a further circuit that implements a further embodiment of a device according to the present disclosure;

FIG. 6 shows a further circuit that implements an embodiment of a device according to the present disclosure;

FIG. 7 shows a circuit that implements a different embodiment of a device according to the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Like reference numerals have been used throughout the figures where common elements exist in different embodiments.

There are various common features, present in all embodiments. A device 10 is initiated using a switch 12 and comprises a thermistor 20, a power supply 30, an Analogue to Digital (ADC) converter 40 and voltage divider 44, 45, a processor (MCU) 50. The processor, or microcontroller 50 and the ADC 40 may be packaged together as indicated by the enclosing dashed line. These are 5V devices.

The thermistor 20 is a temperature-dependent resistance, which is positioned in a location that should, under normal operating conditions, be submerged in oil. The thermistor 20 has an exponential resistance function with temperature. As a result, within an automotive application, where temperatures may range from a cold start −40° C. to an engine operating temperature in the region of 150° C., the resistance may range from 800 kΩ at −40° C. to 530Ω at 150° C.

The power supply 30 is a battery that is of known, but uncontrolled voltage, V_{BAT}, which may typically be a 12V supply. The use of a battery without current stabilization provides a considerable simplification on systems typically deployed. This power supply does not constitute a regulated current source as it lacks the required stabilization. The voltage is known, but is not necessarily constant.

The device 10 is activated using a switch 12 which, when activated, enables the power supply 30 to provide a short burst of power comprising a predetermined quantum of energy. The switch 12 is a PMOS in the illustrated embodiments. However, it will be understood that any suitable control switch could be substituted. When the device 10 is activated, current from the battery 30, V_{BAT} is provided to the thermistor 20 through either resistor R1 or R2, and the ADC 40 reads the voltage across the thermistor 20. The resistance of the thermistor 20 is dependent on the temperature and therefore a measurement effectively provides a reading of the temperature of the thermistor 20.

The ADC 40 converts an analogue response of the thermistor 20 to provide a digital output indicative of a change in resistance of the thermistor 20 as a result of the self-heating induced by the provision of power from the power supply 30.

The processor or microcontroller unit (MCU) 50 then translates a digital response from the ADC 40 into oil temperature and level information. The MCU 50 also includes a memory, which store predetermined acceptable ranges for the oil level and temperature. If the MCU 50 determines that the oil temperature or oil level is outside the predetermined acceptable range, the MCU 50 provides this determination to an alert system. The alert system may provide an audible alarm to notify a driver or the alert may take the form of a visual warning, which may be displayed on a dashboard, on an infotainment system.

The ADC 40 is able to measure an unregulated voltage using a voltage divider comprising a resistor R4, 44 and R5, 45. In the illustrated embodiments R4, 44 is 16 kΩ and R5, 45 is 4 kΩ thereby providing a 4:1 ratio between resistors R4, 44 and R5, 45. This exact ratio is not required. Instead, the resistors R4, 44 and R5, 45 should permit the unregulated supply voltage to be reduced to a voltage level compatible with an ADC range that would commonly be 0-5V. Commonly this would be ratios in a region of 4:1. A provision of the voltage divider enables voltage of the power source 30 to be measured. The ability to measure voltage of the power source 30 obviates a need for voltage to be fixed and known as it can be measured dynamically.

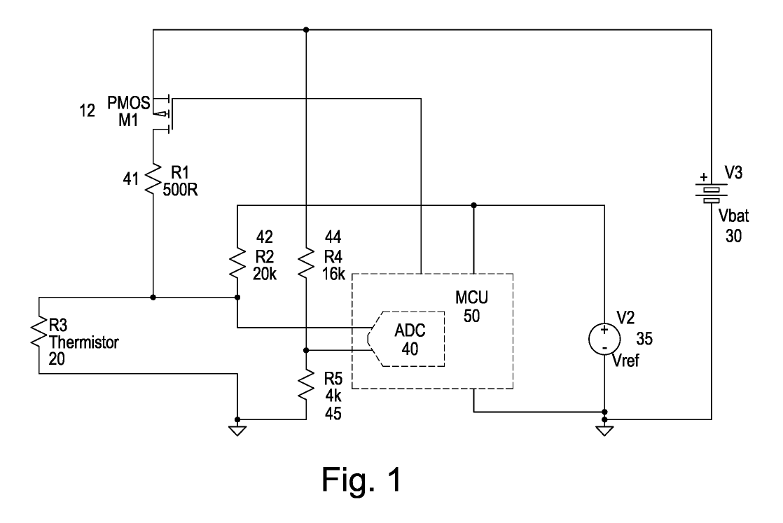

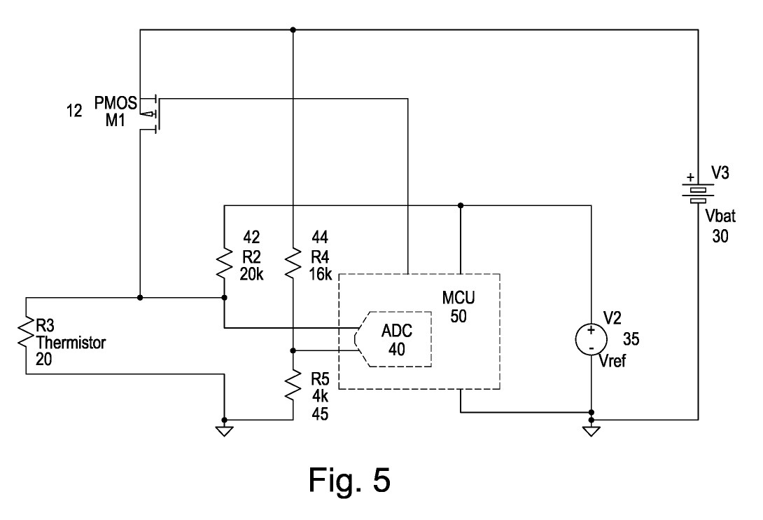

In the embodiments illustrated in FIGS. 1 to 4, 6, and 7, there is further provided an additional resistor R1, 41. This resistor R1, 41 limits current through the switch 12 in event of a short to ground fault to protect the switch 12. The resistor R1, 41 and the thermistor 20 also form a voltage divider that, in embodiments without resistor R2, 42, shall be compatible with the voltage range of the ADC 40. The device 10 illustrated in the embodiment shown in FIG. 5 does not have this resistor R2, 42 and therefore this device 10 would be operated for a shorter time period than embodiments that include resistor R1, 41. The maximum energy delivered to the thermistor 20 by the battery 30 would be comparable to in all embodiments, but this would be delivered over a shorter time period in the embodiment in FIG. 5 where all of the energy delivered is provided to the thermistor 20. In contrast, in the embodiments shown in FIGS. 1 to 4, voltage will be split between resistor R1, 41 and the thermistor R2, 42. In the illustrated embodiments, thermistor 20 is 500Ω at 150° C. and 900 kΩ at −40° C.

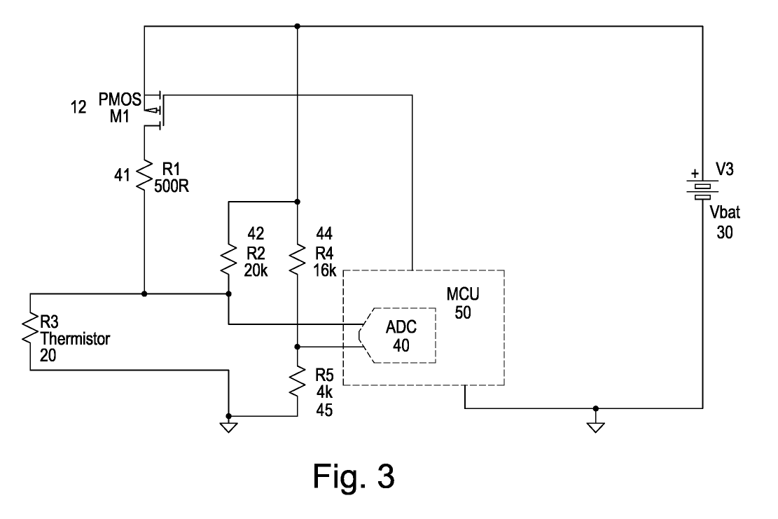

In the embodiments illustrated in FIGS. 1, 3, and 5, there is a resistor R2, 42. In the embodiments illustrated in FIGS. 1 and 3, this is provided in addition to resistor R1, 41, whereas in the embodiment illustrated in FIG. 5, the resistor R2, 42 is provided instead of the resistor R1, 41. This resistor R2, 42 is connected between the thermistor 20 and the ADC 40. In the illustrated embodiments, resistor R2, 42 has a resistance of 20 kΩ, which exceeds a resistance of the resistors R4 and R5, 44, 45 in the voltage divider. It ensures that there is only a small current through the thermistor 20 and thereby protects the thermistor 20 from excessive heating. It also ensures that there is still a voltage divider, deploying a thermistor resistance as another resistor, so that the voltage range across the ADC 40 is within a measureable voltage range of the ADC 40. It is important that either resistor R1, 41 or resistor R2, 42 is provided. In some embodiments, including those shown in FIGS. 1 and 3, both resistors R1, 41 and R2, 42 are provided.

When only one resistor, selected from between R1, 41 and R2, 42, is present, a resistance of that resistor R1, 41, R2, 42 is selected to ensure that voltage across the thermistor 20 remains within the 0-5V operational envelope of the ADC 40 and MCU 50 for all reasonable temperature values of the oil.

As illustrated in the embodiments shown in FIGS. 1, 4, 5, 6, and 7 a reference voltage V_{REF} 35 can be provided between the MCU 50 and ground. This is necessary where the MCU is a 5V device that requires voltage stabilization.

An example of a heating duration could be as follows: If 10 mJ is to be delivered to the thermistor 20, which is at −1° C. and therefore 100 kΩ, when the switch 12 is closed to activate the device 10, V_{BAT} of 12V flows, providing a current of 120 μA and a power of 1.44 mW. This therefore requires 7 s of heating to provide the 10 mJ.

If the thermistor 20 is at 100° C. and therefore 2.08 kΩ, a current of 4.65 mA and a power of 45 mW is provided. The heating time is therefore 0.22 s.

The embodiment illustrated in FIG. 1 includes both resistors R1, 41 and R2, 42 as well as a reference voltage V2, 35. This optimizes both oil level and temperature sensing and provides a robust solution.

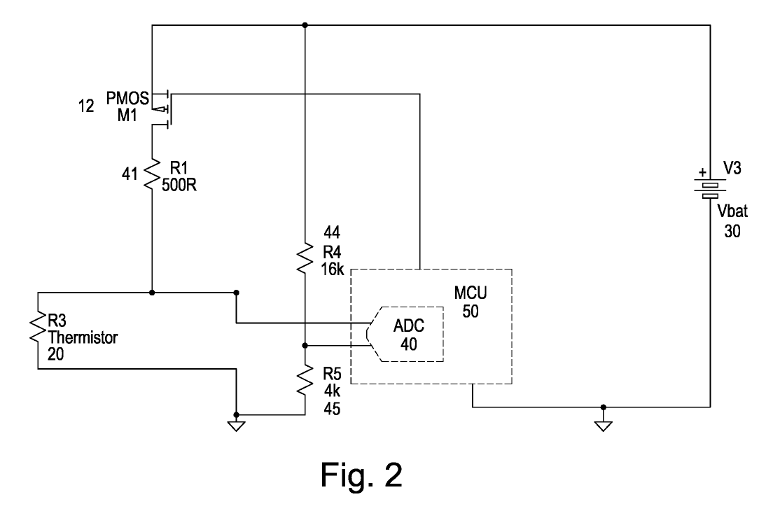

The embodiment illustrated in FIG. 2 has only resistor R1, 41. Resistor R2, 42 is not present in this embodiment. This provides a slight cost saving in comparison with the embodiment illustrated in FIG. 1. A lower resistance thermistor, for example a factor of 100 lower, will be used in comparison to the thermistor of FIG. 1 in order to accommodate the temperature range within the operational range of the ADC 40. The device 10 will be operated using the switch 12 for a short period, for example 5 μs, for reading. This time frame is selected as it is considerably too short to have any heating effect. A long switch, of between 0.1 s and 10 s, 20 s or even 30 s, is used for heating.

The embodiment illustrated in FIG. 3 omits the reference voltage V_{REF} 35 and thereby provides a further cost saving by removing the regulated power supply. In this embodiment, a measurement of the unregulated supply is used to define a voltage from which the temperature is subsequently derived. This approach is slightly less accurate than the embodiment illustrated in FIG. 1.

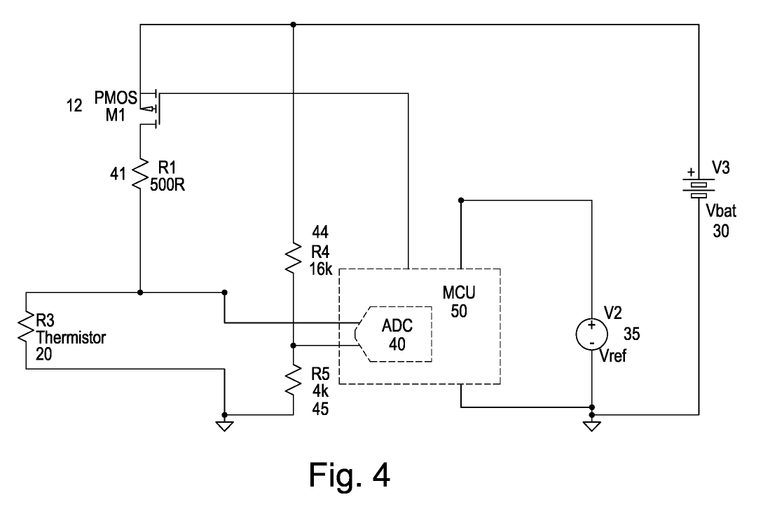

The embodiment illustrated in FIG. 4 is a further implementation of the embodiment illustrated in FIG. 2. This is applicable where the MCU 50 has its own power supply, regulated in whatever manner is appropriate to operation of the MCU itself. Therefore, the reference voltage V_{REF} 35 is not required.

The embodiment illustrated in FIG. 5 uses resistor R2, 42 alone and the embodiment illustrated in FIG. 5 does not have resistor R1, 41. In this embodiment, the ADC 40 is used to monitor for a short to ground. When the switch 12 is closed so that the device 10 is active, voltage at the thermistor 20 will be pulled up to V_{BAT}, which is typically 12V and therefore outside an active range of the ADC 40 and MCU 50. When the switch 12 is open, resistor R2, 42 therefore acts to lower voltage across the thermistor 20 so that it falls within the 0-5V operable range of the ADC 40. The ADC 40 also provides some protection for the switch 12, by detecting short to ground, the switch 12 can be turned off by the microcontroller 50. Resistor R2, 42 is used to measure a temperature of the thermistor 20. This is a more accurate configuration than the embodiment illustrated in FIG. 3 because it used a stabilized voltage source, reference voltage V_{REF} 35, for measurement.

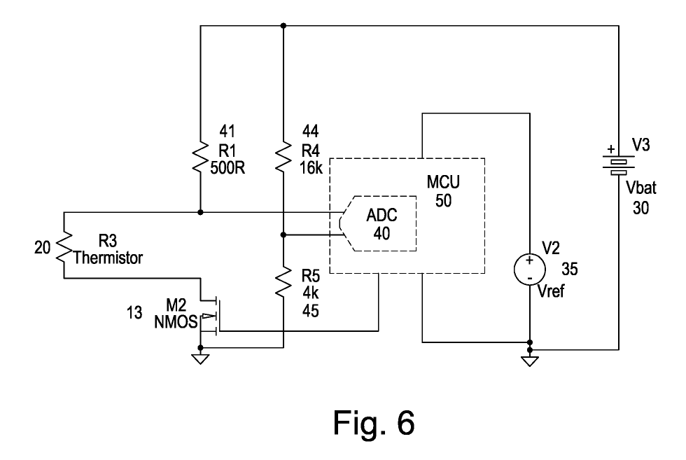

The embodiment illustrated in FIG. 6 uses a low switch 13 to isolate the thermistor 20 so that it cannot overheat in the event of a short to the battery 30.

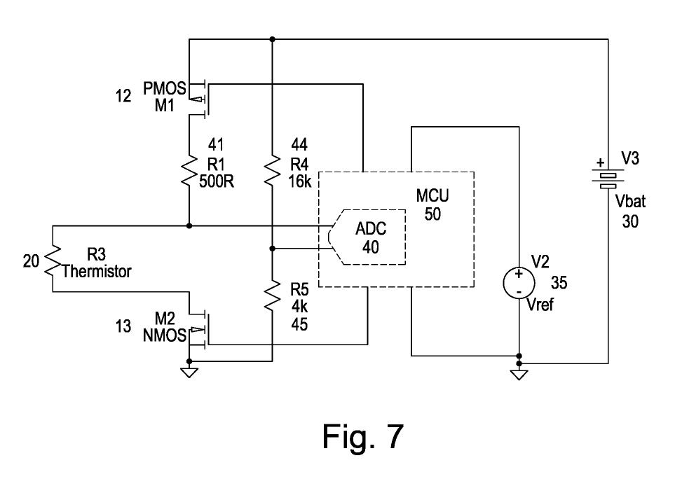

The embodiment illustrated in FIG. 7 uses a low switch 13 in addition to the high switch 12 deployed in the embodiments illustrated in FIGS. 1 to 5. This embodiment optimizes protection of the circuit. The resistance of the thermistor 20 is low when the temperature is high and, therefore, the circuit is configured with two switches 12, 13 to enable the thermistor 20 to be isolated by switching the high switch 12 off in the case of a short to ground. Alternatively, in the case of a short to battery 30, the low switch 13 can be opened.

It will further be appreciated by those skilled in the art that although the disclosure has been described by way of example with reference to several embodiments it is not limited to the disclosed embodiments and that alternative embodiments could be constructed without departing from the scope of the disclosure as defined in the appended claims.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. An engine oil and temperature detection controller comprising:
a voltage-only regulated power supply configured to provide a non-continuous high current to a thermistor for a predetermined time to induce self-heating of the thermistor;
an Analogue to Digital converter (ADC) configured to measure voltage across the thermistor before and after heating the thermistor; and
a processor configured to, in response to a change in temperature of the thermistor calculated from a change in voltage, deduce an oil level and a temperature.

2. The engine oil and temperature detection device of claim 1 further comprising a storage device configured to store a range of operating parameters for the oil.

3. The engine oil and temperature detection device of claim 2 further comprising an alarm system configured to trigger an alarm when the oil level and/or temperature are outside of the range of the operating parameters.

4. The engine oil and temperature detection device of claim 1 further comprising a voltage divider configured to separate the thermistor from the ADC.

5. The engine oil and temperature detection device of claim 1 further comprising a control switch to provide a fixed burst of energy to the thermistor for a predetermined period of non-continuous operation.

6. The engine oil and temperature detection device of claim 5, wherein the control switch is a p-channel metal-oxide semiconductor (PMOS).

7. The engine oil and temperature detection device of claim 5 further comprising a resistor connected in series with the control switch to limit current through the control switch to protect the control switch from a short to ground fault.

8. The engine oil and temperature detection device of claim 1, wherein the processor is further configured to provide a reference voltage to regulate the power supply.

9. A vehicle comprising:
an unregulated power supply configured to provide a non-continuous, high current to a thermistor for a predetermined time to induce self-heating of the thermistor;
an Analogue to Digital converter (ADC) configured to measure voltage across the thermistor before and after heating the thermistor;
a processor configured to, in response to a change in temperature of the thermistor calculated from a change in voltage, deduce an oil level and temperature;
a storage device configured to store a range of operating parameters for the oil; and
an alarm configured to trigger when the oil level and temperature are outside the range.

10. The vehicle of claim 9 further comprising a voltage divider configured to separate the thermistor from the ADC.

11. The vehicle of claim 9 further comprising a control switch to provide a fixed burst of energy to the thermistor for a predetermined period of non-continuous operation.

12. The vehicle of claim 11, wherein the control switch is a p-channel metal-oxide semiconductor (PMOS).

13. The vehicle of claim 12 further comprising a resistor connected in series with the control switch to limit current through the control switch to protect the control switch from a short to ground fault.

14. The vehicle of claim 9, wherein the processor is further configured to store a reference voltage to regulate the power supply.

15. An engine oil control system comprising:
a controller configured to deduce an oil level and temperature, in response to a temperature change of a thermistor during a period of self-heating induced by an unregulated power supply that provides a non-continuous, high current for a predetermined period of time, calculated from a voltage change measured, via an Analogue to Digital converter (ADC), across the thermistor before and after the predetermined period.

16. The engine oil control system of claim 15 further comprising a voltage divider configured to separate the thermistor from the ADC.

17. The engine oil control system of claim 15 further comprising a switch to provide a fixed burst of energy to the thermistor for a predetermined period of non-continuous operation.

18. The engine oil control system of claim 17, wherein the switch is a p-channel metal-oxide semiconductor (PMOS).

19. The engine oil control system of claim 18 further comprising a resistor connected in series with the switch to limit current through the switch to protect the switch from a short to ground fault.

20. The engine oil control system of claim 15, wherein the controller is further configured to store a reference voltage to regulate the power supply.
